(19) United States
(12) Patent Application Publication
(10) Pub. No.: US 2022/0337315 A1
(43) Pub. Date: Oct. 20, 2022

(54) COMMUNICATION SYSTEM FOR TRANSPORT MEANS

(71) Applicant: TOYOTA JIDOSHA KABUSHIKI KAISHA, Toyota-shi (JP)

(72) Inventors: Kaoru YOSHIDA, Nisshin-shi (JP); Shiori FURUTA, Toyota-shi (JP); Kazuya KITATANI, Toyota-shi (JP); Daiki HAYAKAWA, Toyota-shi (JP)

(73) Assignee: TOYOTA JIDOSHA KABUSHIKI KAISHA, Toyota-shi (JP)

(21) Appl. No.: 17/655,826

(22) Filed: Mar. 22, 2022

(30) Foreign Application Priority Data
Apr. 16, 2021 (JP) 2021-069527

(51) Int. Cl. H04B 10/112; H04B 10/116; H04L 67/00; H04B 3/54

(52) U.S. Cl. CPC H04B 10/1127; H04B 10/116; H04L 67/34; H04B 3/54

(57) ABSTRACT

A communication system for transport means is provided, by which wireless communication is performed between the outside and the wireless communication environment in the transport means. Optical wireless communication is performed between a terminal device 2 and a light source device 3. A body ECU 4 connected to the light source device 3 by wired connection is further connected, by the wired connection, to a DCM 7 performing wireless communication with the outside. The light source device 3 and the body ECU 4 communicate with each other by power line communication. Accordingly, the light source device 3 sends and receives information between the outside via the body ECU 4 and the DCM 7. Thus, a vehicle communication system 1 that realizes wireless communication between the outside and the in-vehicle wireless communication environment (in-vehicle wireless communication environment configured including the terminal device 2 and the light source device 3) is built.

### CROSS-REFERENCE TO RELATED APPLICATIONS

The present application claims priority under 35 U.S.C. § 119(a) to Japanese Patent Application No. 2021-069527, filed on Apr. 16, 2021. The contents of this application are incorporated herein by reference in its entirety.

### TECHNICAL FIELD

The present invention relates to a communication system for transport means. Especially, the present invention relates to a communication system for transport means, by which a terminal device in the interior of transport means such as an automobile can communicate with the outside.

### BACKGROUND ART

Conventionally, a communication system as disclosed in Patent Document 1 is known, by which a terminal device in the interior of transport means is capable of communicating via a communication network.

In the communication system disclosed in Patent Document 1, an interior lamp with communication function, which is connected to a wired communication network, includes an LED that transmits information (signal) to a seat and a display device by visible light communication. Also, the seat and the display device each include: a light receiving part that receives information transmitted from the interior lamp with communication function; and a control part that controls its proper operations based on the information received by the light receiving part. In this way, wiring for telecommunication to be connected to the seat and the display device is not required, which leads to reduction in the number of wires in transport means.

### PRIOR ART DOCUMENT

### Patent Document

[Patent Document 1] JP 2020-083172 A

### SUMMARY OF THE INVENTION

### Problem to be Solved by the Invention

However, in the system disclosed in Patent Document 1, the interior lamp with communication function including the LED that transmits information (in Patent Document 1, information generated by visible light) is connected to the wired communication network. More specifically, information transmitted from a host device installed in the first car of a railroad vehicle is received by the interior lamp with communication function via the wired communication network. That is, the communication mode between the host device as a source to send information and the interior lamp with communication function (i.e. the interior lamp with communication function that wirelessly communicates with the seat and the display device both corresponding to the terminal device) is wired communication. Thus, Patent Document 1 does not disclose any technique by which the interior lamp with communication function (communication device) can communicate with the outside of the vehicle (outside) via wireless communication. As a result, there is a room for realizing wireless communication between the outside and the in-vehicle wireless communication environment (wireless communication environment including an in-vehicle terminal device and a communication device that wirelessly communicates with the terminal device).

The present invention was made in consideration of the above circumstances, an object of which is to provide a communication system for transport means, by which an in-vehicle wireless communication environment can wirelessly communicate with the outside.

### Means for Solving the Problem

In order to achieve the above object, a communication system for transport means of the present invention includes: a communication device performing wireless communication with a terminal device in the interior of transport means; a control device connected to the communication device by a power distribution line; and a wireless communication device connected to the control device by wired connection, which performs wireless communication with the outside. The communication device and the control device communicate with each other by power line communication using the power distribution line.

Here, the wired connection between the control device and the wireless communication device includes the direct wired connection of these devices and the wired connection of these devices via another device (for example, a relay device).

With the above-described configuration, the in-vehicle wireless communication environment configured including the terminal device and the communication device that can communicate with each other by wireless communication in the interior of the transport means can perform wired communication with the control device by power line communication (PLC) using the power distribution line on which communication signals can be superimposed. Also, since the control device is connected, by wired connection, to the wireless communication device capable of wirelessly communicating with the outside, the communication device can send information to and receive information from (or only receive information from, or only send information to) the outside via the control device and the wireless communication device. Thus, it is possible to build the communication system for transport means that realizes wireless communication between the outside and the in-vehicle wireless communication environment.

Also, operations to evaluate communication quality are performed by sending and receiving communication quality evaluation signals between the communication device and the control device under a plurality of communication conditions using the power distribution line so as to select and determine a communication condition between the communication device and the control device using the power distribution line among the plurality of communication conditions.

The communication system mounted on transport means such as an automobile (i.e. communication system for transport means) has complicated communication paths. Thus, in order to put the present invention into practical use, it is important to perform operations to evaluate the communication quality (i.e. whether the stable communication state is ensured) so that an evaluation result of the communication quality serves to adjust various parameters for communication. In view of the foregoing, in the present invention, the operations to evaluate the communication quality between the communication device and the control device are performed, and the communication condition evaluated to have the highest communication quality is selected so as to perform the communication between the communication device and the control device. In this way, it is possible to ensure the stable communication state between the communication device and the control device, which improves practicability of the communication system for transport means.

Also, in the operations to evaluate the communication quality, first operations to evaluate the communication quality are performed by sending the communication quality evaluation signals from the control device to the communication device using the power distribution line, and furthermore second operations to evaluate the communication quality are performed by sending the communication quality evaluation signals from the communication device to the control device using the power distribution line.

With the above-described configuration, the operations to evaluate the communication quality are performed with respect to the communication using power distribution line, not only in one direction but also in the opposite direction. Thus, it is possible to improve accuracy in the evaluation of the communication quality.

Also, the result of the operations to evaluate the communication quality between the communication device and the control device is output, specifically, from the communication device to the interior of the transport means.

For example, when an occupant is in the transport means, it is possible to notify the occupant of the result of the operations to evaluate the communication quality between the communication device and the control device by the output from the communication device (for example, notification with light or sound). Thus, the occupant can recognize the communication state (communication quality) in the communication system for transport means.

In this case, the communication device includes a light emitter. And the result of the operations to evaluate the communication quality, which is output from the communication device to the interior of the transport means, is indicated by the light emitter as a color of emitted light or a flash of emitted light that is determined in advance corresponding to the result.

With the above-described configuration, when the occupant is in the transport means, it is possible for the occupant to easily recognize the communication state between the communication device and the control device by seeing the light emitted from the light emitter of the communication device. In this configuration, the light emitter provided in the communication device may be a light emitter for optical wireless communication (described later), or may be a light emitter only for outputting the result of the operations to evaluate the communication quality.

Also, the result of the operations to evaluate the communication quality is fed back to the control device so as to adjust the communication condition between the control device and the communication device.

In this way, the communication condition is adjusted to reflect the result of the operations to evaluate the communication quality. Thus, it is possible to ensure the stable communication state between the communication device and the control device, which improves practicability of the communication system for transport means.

Also, the operations to evaluate the communication quality between the terminal device and the communication device are performed by the wireless communication. Thus, the result of the operations to evaluate the communication quality is fed back to the communication device so as to adjust the communication condition between the communication device and the terminal device.

In this way, the communication condition is adjusted to reflect the result of the operations to evaluate the communication quality. Thus, it is possible to ensure the stable communication state between the communication device and the terminal device, which also improves practicability of the communication system for transport means.

The wireless communication performed between the terminal device and the communication device is, specifically, optical wireless communication.

The optical wireless communication can realize a high transfer rate. Also, since the optical wireless communication does not cause radio interference, stable communication may be achieved. Furthermore, since the optical wireless communication does not generate any electromagnetic wave, the electronic devices mounted on the transport means are not affected. Thus, it is possible to perform stable communication at high speed with the terminal device in the interior of the transport means.

Also, the communication device includes a light emitter and a light receiver to perform optical wireless communication with the terminal device, or includes only the light emitter to send information to the terminal device by the optical wireless communication.

When the communication device includes both the light emitter and the light receiver, and furthermore when the terminal device also includes a light emitter and a light receiver, the communication device can perform two-way communication with the terminal device. When the communication device includes only the light emitter, and furthermore when the terminal device includes a light receiver, the communication device can perform one-way communication with the terminal device. Thus, it is possible to realize the optical wireless communication as the wireless communication mode between the terminal device and the communication device.

Also, when the communication device includes only the light emitter, the operations to evaluate the communication quality at least between the control device and the communication device on a communication path from the control device to the terminal device are performed, and the result of the operations to evaluate the communication quality is fed back from the terminal device to the control device so as to adjust the communication condition on the communication path from the control device to the terminal device.

In the above-described communication system for transport means by which the one-way communication can be performed, the communication condition is adjusted to reflect the result of the operations to evaluate the communication quality. Thus, it is possible to ensure the stable communication state on the communication path from the control device to the terminal device, which improves practicability of the communication system for transport means.

### Advantageous Effect of the Invention

In the present invention, optical wireless communication is performed between a terminal device and a communication device. A control device connected to the communication device by wired connection is further connected, by the wired connection, to a wireless communication device performing wireless communication with the outside. The communication device and the control device communicate with each other by power line communication using a power distribution line. Accordingly, the communication device sends and receives information between the outside via the control device and the wireless communication device. Thus, a communication system for transport means that realizes wireless communication between the outside and the in-vehicle wireless communication environment (in-vehicle wireless communication environment configured including the terminal device and the communication device) is built.

### BRIEF DESCRIPTION OF THE DRAWINGS

FIG. 1 is a diagram schematically illustrating a configuration of a vehicle communication system according to an embodiment.

FIG. 2 is a block diagram indicating the vehicle communication system.

FIG. 3 is a flowchart indicating a procedure of preparation for building the vehicle communication system according to the embodiment.

FIG. 4 is a diagram explaining replacement patterns of a light source device.

FIG. 5 is a flowchart indicating a procedure of first operations to evaluate communication quality.

FIG. 6 is a diagram illustrating an example of installation locations of in-vehicle light source devices.

FIG. 7 is a flowchart indicating a procedure of second operations to evaluate communication quality.

FIG. 8 is a block diagram corresponding to FIG. 2, which explains processing according to a result of operations to evaluate the communication quality.

FIG. 9 is a diagram illustrating an interior of a vehicle in order to explain an example of usage state of the vehicle communication system.

FIG. 10 is a diagram illustrating the interior of the vehicle in order to explain an example of a state in which the communication is not established in the vehicle communication system.

FIG. 11 is a block diagram corresponding to FIG. 2, which explains processing according to a result of operations to evaluate communication quality in a variation.

FIG. 12 is a schematic diagram illustrating an example in which the vehicle communication system is applied to a transit bus.

### DESCRIPTION OF EMBODIMENTS

Hereinafter, an embodiment of the present invention will be described with reference to the drawings. In this embodiment, the communication system for transport means of the present invention is applied to an automobile. Therefore, in this embodiment, the communication system for transport means is expressed as a “vehicle communication system”, and the interior of the transport means is expressed as an “interior of a vehicle (in-vehicle)”. Also, as to a wireless communication mode in the interior of a vehicle, an example is described, in which optical wireless communication (Li-Fi: Light Fidelity) is used. Also as the in-vehicle wireless communication mode of the present invention, Bluetooth (registered trademark) or Wi-Fi (registered trademark) may be used.

Also in this embodiment, an example is described, in which the vehicle communication system of the present invention is introduced (retrofitted) in a vehicle on which the vehicle communication system of the present invention is not mounted (i.e. an existing vehicle). However, the technical idea of the present invention is not limited to the case in which the vehicle communication system is newly introduced, but includes a case in which the vehicle communication system of the present invention is installed when manufacturing the vehicle (i.e. the case in which the vehicle communication system is already mounted on a new vehicle).

Also in this embodiment, an example is described, in which the vehicle communication system is built as a communication mode in which information can be sent and received reciprocally (hereinafter occasionally referred to as “two-way communication”) between a terminal device in the interior of a vehicle and the outside of the vehicle (for example, internet; more specifically, a server of an internet service provider, which is being connected to the internet). However, the technical idea of the present invention is not limited to the vehicle communication system in which the two-way communication is performed, but includes the system that is built such that the terminal device only receives information from the outside of the vehicle (hereinafter occasionally referred to as “one-way communication).

### —Overall Configuration of Vehicle Communication System—

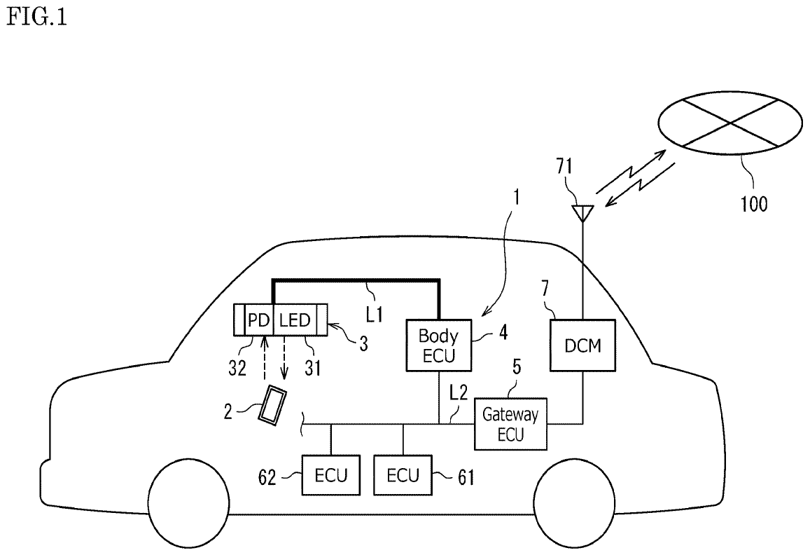

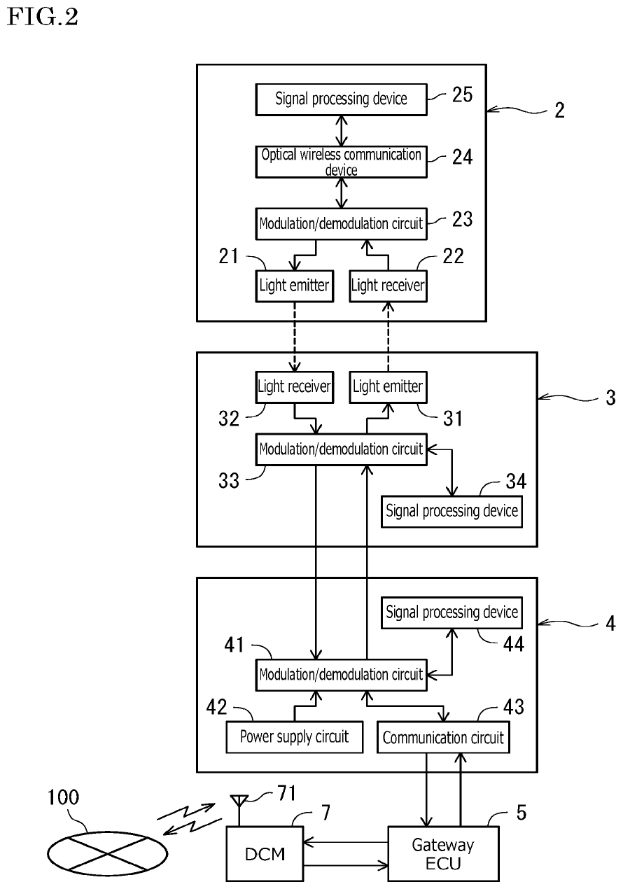

FIG. 1 is a diagram schematically illustrating a configuration of a vehicle communication system 1 according to this embodiment. FIG. 2 is a block diagram indicating the vehicle communication system 1. As shown in FIG. 1, the vehicle communication system 1 according to this embodiment is built as a communication system in which information is sent from and received by a terminal device 2 in the interior of a vehicle (for example, a smartphone or the like carried by an occupant).

Specifically, the vehicle communication system 1 includes: a light source device 3 as a communication device; a body ECU (Electronic Control Unit) 4; a gateway ECU 5; and various ECUs 61 and 62 as respective control devices; and a DCM (Data Communication Module) 7 as a wireless communication device.

The light source device 3 and the body ECU 4 are connected to each other by a power distribution line L1. This power distribution line L1 not only supplies power to the light source device 3 (i.e. power supply for lighting), but also performs power line communication (PLC) between the light source device 3 and the body ECU 4.

Also, by connecting the body ECU 4, the gateway ECU 5, the various ECUs 61 and 62 and the DCM 7 by a signal line L2 (i.e. wired connection), the two-way communication can be performed via an in-vehicle network according to communication protocols such as CAN (Controller Area Network), Ethernet and the like. The body ECU 4, the gateway ECU 5, the various ECUs 61 and 62, and the DCM 7 are each realized by a computer including a CPU (Central Processing Unit), a RANI (Random Access Memory), a ROM (Read Only Memory), a clock generator, an input-output interface, a communication interface, and internal buses.

Hereinafter, the terminal device 2 and the respective components of the vehicle communication system 1 will be described.

### (Terminal Device)

The terminal device 2 is, for example, a portable terminal such as a smartphone carried by an occupant in a vehicle. The terminal device can perform optical wireless communication (Li-Fi: registered trademark) with the light source device 3.

As shown in FIG. 2, the terminal device 2 includes: a light emitter 21; a light receiver 22; a modulation/demodulation circuit 23; an optical wireless communication device 24; and a signal processing device 25.

Specifically, an LED (Light Emitting Diode) can be adopted as the light emitter 21. Also, a PD (Photodiode) can be adopted as the light receiver 22. Thus, a light flashing pattern emitted by the light emitter 21 can be transmitted, as a transmission signal (digital signal), to the light source device 3. Also, a light flashing pattern detected by the light receiver 22 can be received, as a reception signal, from the light source device 3.

Here, the advantages of Li-Fi are briefly described. Li-Fi can realize the transfer rate not less than 5 Gbps, which means that information can be sent and received at extremely high speed. The light used for Li-Fi is not limited to the visible light. The infrared light and the ultraviolet light may also be used. Also, since Li-Fi does not cause radio interference, stable communication can be achieved. Furthermore, since Li-Fi does not generate any electromagnetic wave, electronic devices mounted on the vehicle are not affected, which leads to realization of stable operations of the electronic devices. In the configuration of this embodiment, it is possible to perform wireless communication (optical wireless communication) between the terminal device 2 and the light source device 3 using Li-Fi having various advantages as described above.

The modulation/demodulation circuit 23 modulates optical signals to be transmitted to the light source device 3, and demodulates optical signals received from the light source device 3. The optical wireless communication device 24 generates an optical signal to be transmitted to the light source device 3, and outputs the generated optical signal to the modulation/demodulation circuit 23. Also, the optical wireless communication device 24 receives, from the modulation/demodulation circuit 23, information after demodulation of the optical signal from the light source device 3. The signal processing device 25 sends information to and receives information from the optical wireless communication device 24. Thus, the signal processing device 25 performs, based on information (communication information) received from the optical wireless communication device 24: processing to output image display or the like to a user interface such as a display device (monitor) provided in the terminal device 2; generation of information based an operation when an occupant operates the terminal device 2 (i.e. information on operation instructions from the occupant); processing of information on operations to evaluate the communication quality described later; generation of result information on the operations to evaluate the communication quality; and generation of adjustment information on the communication condition to feed back to the light source device 3.

### (Light Source Device)

The light source device 3 performs optical wireless communication (Li-Fi) with the terminal device 2. Also, since the light source device 3 is connected to the body ECU 4 by the power distribution line L1 as described above, the light source device 3 can send information to and receive information from the body ECU 4 (i.e. can communicate with each other) by power line communication in which communication signals are superimposed on the power distribution line L1.

Also as shown in FIG. 2, the light source device 3 includes: a light emitter 31; a light receiver 32; a modulation/demodulation circuit 33; and a signal processing device 34.

In particular, an LED can be adopted as the light emitter 31, and a PD can be adopted as the light receiver 32. Thus, it is possible to transmit the light flashing pattern to the terminal device 2 as a transmission signal (digital signal) by operations of a drive circuit (Tx driver) provided in the light emitter 31. Also, it is possible to receive the light flashing pattern from the terminal device 2 as a reception signal by operations of a drive circuit (Rx driver) provided in the light receiver 32.

The modulation/demodulation circuit 33 modulates signals to be transmitted to the body ECU 4, and demodulates signals received from the body ECU 4. That is, the modulation/demodulation circuit 33 modulates/demodulates the communication signals sent/received by being superimposed on the power distribution line L1. The signal processing device 34 sends information to and receives information from the modulation/demodulation circuit 33. Thus, the signal processing device 34 performs, based on information (communication information) received from the modulation/demodulation circuit 33: processing of information on operations to evaluate the communication quality described later; generation of result information on the operations to evaluate the communication quality; and output of the result information.

### (Body ECU)

The body ECU 4 is connected, by the signal line L2, to the ECUs 61 and 62 that control various devices mounted on the vehicle, and transmits control signals to the ECUs 61 and 62 to control the various devices. Examples of the various devices include a door lock device and lamps (not shown). Also, as previously described, the body ECU 4 is connected to the light source device 3 by the power distribution line L1, and thus is capable of sending information to/receiving information from (i.e. communicating with) the light source device 3 by power line communication using the power distribution line L1.

Also, as shown in FIG. 2, the body ECU 4 includes: a modulation/demodulation circuit 41; a power supply circuit 42; a communication circuit 43; and a signal processing device 44.

The modulation/demodulation circuit 41 modulates signals to be transmitted to the light source device 3, and demodulates signals received from the light source device 3. That is, the modulation/demodulation circuit 41 modulates/demodulates the communication signals sent/received by being superimposed on the power distribution line L1. The power supply circuit 42 is connected, by a power distribution line (not shown), to a battery (storage battery) mounted on the vehicle, and supplies electric power received from the battery to the modulation/demodulation circuit 41. The communication circuit 43 is connected to the gateway ECU 5 (wired connection), and sends information to and receives information from the gateway ECU 5. The signal processing device 44 sends information to and receives information from the modulation/demodulation circuit 41. Thus, the signal processing device 44 performs, based on the information (communication information) received from the modulation/demodulation circuit 41: processing of information on operations to evaluate the communication quality described later; generation of result information on the operations to evaluate the communication quality; and output of the result information.

### (Gateway ECU)

The gateway ECU 5 is connected to the DCM 7, the body ECU 4, and the ECUs 61 and 62 via the in-vehicle network. The gateway ECU 5 is a relay device that relays communication between the above devices. Also, the gateway ECU 5 can be connected to a predetermined network (internet) 100 outside of the vehicle via the DCM 7.

### (ECUs)

As described above, the ECUs 61 and 62 are, for example, to control the door lock device, the lamps and the like (not shown). In FIG. 1, two ECUs 61 and 62 are exemplarily shown. However, many ECUs are actually mounted on the vehicle, examples of which include: an engine ECU; a brake ECU; a steering ECU; a transmission ECU; a meter ECU; and an air conditioner ECU.

### (DCM)

The DCM 7 is a communication device capable of performing two-way communication via a predetermined network 100 including the mobile telephone network having a number of base stations and the internet network, under the control by the gateway ECU 5. Specifically, the DCM 7 can communicate with the outside of the vehicle (for example, the network 100 such as internet) via a vehicle external antenna 71. In particular, the DCM 7 performs wireless communication via the communication line such as 3G (Generation), 4G, LTE, and 5G. In brief, the DCM 7 can be connected to the network 100 via any of the above listed communication lines.

Thus, the terminal device 2 and the respective components 3, 4, 5, 61, 62 and 7 in the vehicle communication system 1 were described.

### —Preparation Procedure for Building Vehicle Communication System—

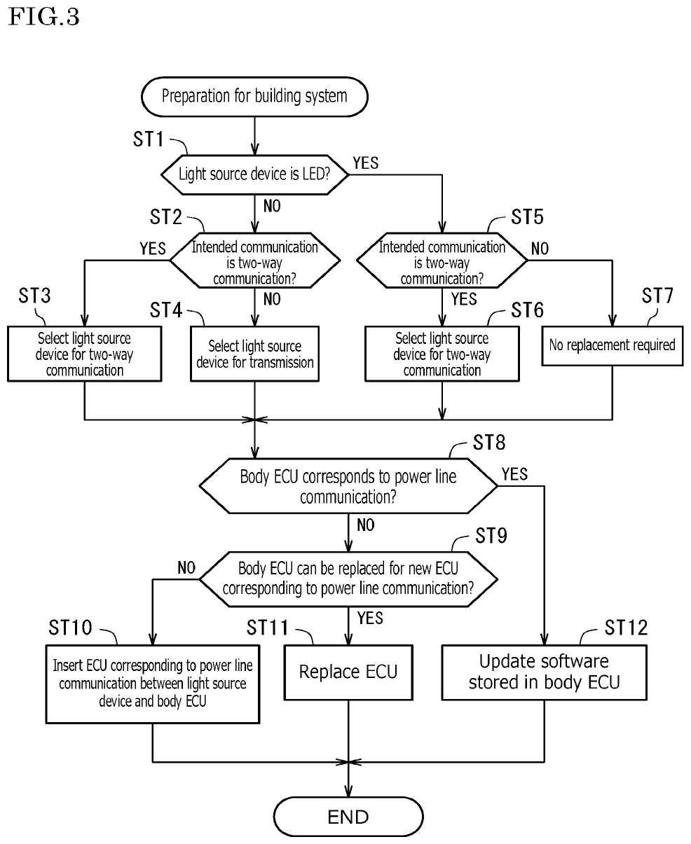

Now, the preparation procedure for building the above-configured vehicle communication system 1 is described. In this embodiment as described above, the vehicle communication system 1 of the present invention is introduced (retrofitted) in a vehicle on which the vehicle communication system 1 is not mounted (i.e. an existing vehicle). That is, in order to build the vehicle communication system 1, parts replacement and software updates are needed depending on the situation. Thus, the preparation procedure for building the vehicle communication system 1 is hereinafter described referring to the flowchart in FIG. 3.

As preparation for building the vehicle communication system 1, in step ST1, it is determined whether the light source device (i.e. light source device currently disposed in the interior of the vehicle) to be used for the vehicle communication system 1 is an LED (i.e. a device having an LED and not having a PD) or not. A room lamp is an specific example of the light source device suitable for the vehicle communication system 1, which is provided on the in-vehicle ceiling surface from where the light is easily emitted to the terminal device 2 held in hand and operated by an occupant who is sitting in a seat. Specifically, in step ST1, it is determined whether the room lamp is an LED not being a light bulb, or not. It is a user who carries out this determination, for example, by confirming a specification of the vehicle or by visually confirming the actual light source device (room lamp). As to the position of the light source device suitable for the vehicle communication system 1 (that is, as to which lamp is to be used as the light source device 3 suitable for the vehicle communication system 1), it is preferable to propose an appropriate lamp in a users' manual or the like.

When the light source device provided in the vehicle is not the LED (i.e. is the light bulb) and thus it is determined to be “NO” in step ST1, the procedure advances to step ST2 where it is determined whether the communication mode that is intended to be introduced as the vehicle communication system 1 is two-way communication or not, out of two-way communication and one-way communication (only transmission to the terminal device 2). For example, when it is necessary to search information using the terminal device 2, it is determined that the intended communication mode is two-way communication. On the other hand, when the terminal device 2 is only required to receive broadcast, it is determined that the intended communication mode is one-way communication.

When the communication mode intended to be introduced is two-way communication and thus it is determined to be “YES” in step ST2, the procedure advances to step ST3 where the light source device 3 (light source device for two-way communication) including the light emitter (LED) 31 and the light receiver (PD) 32 is selected as the light source device 3 for replacement. That is, it is determined that the light bulb should be removed and replaced with the light source device 3 including the light emitter 31 and the light receiver 32 (i.e. light source device capable of sending and receiving optical information).

On the other hand, when the communication mode intended to be introduced is one-way communication (only transmission to the terminal device 2) and thus it is determined to be “NO” in step ST2, the procedure advances to step ST4 where the light source device 3 (light source device for transmission) including only the light emitter (LED) 31 is selected as the light source device 3 for replacement. That is, it is determined that the light bulb should be removed and replaced with the light source device 3 including only the light emitter 31 (i.e. light source device capable of only sending optical information).

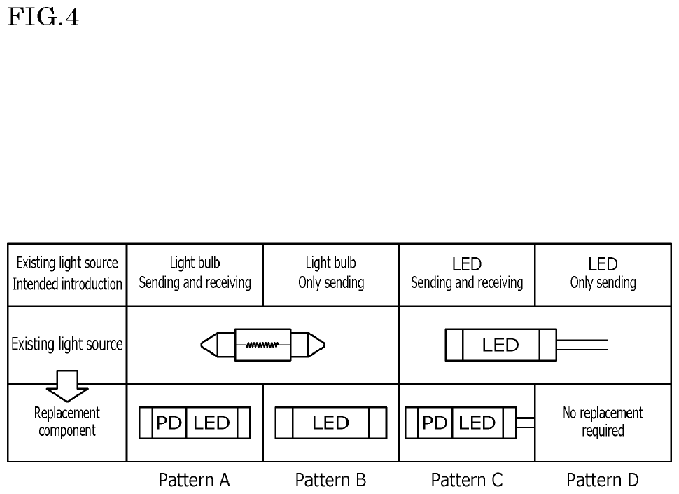

FIG. 4 is a diagram explaining replacement patterns of the light source device 3. When the existing light source is a light bulb and the communication mode intended to be introduced is two-way communication (sending and receiving information), this case corresponds to pattern A in FIG. 4. Thus, it is necessary to remove the light bulb to replace it with the light source device 3 including the light emitter (LED) 31 and the light receiver (PD) 32. When the existing light source is a light bulb and the communication mode intended to be introduced is one-way communication (only sending information), this case corresponds to pattern B in FIG. 4. Thus, it is necessary to remove the light bulb to replace it with the light source device 3 including only the light emitter (LED) 31.

In the flowchart as shown in FIG. 3, when the light source device provided in the vehicle is an LED and it is determined to be “YES” in step ST1, the procedure advances to step ST5 where it is determined whether the communication mode that is intended to be introduced as the vehicle communication system 1 is two-way communication or not, out of two-way communication and one-way communication.

When the communication mode intended to be introduced is two-way communication and thus it is determined to be “YES” in step ST5, the procedure advances to step ST6 where the light source device 3 (light source device for two-way communication) including the light emitter (LED) 31 and the light receiver (PD) 32 is selected as the light source device 3 for replacement. That is, it is determined that the LED should be removed and replaced with the light source device 3 including the light emitter 31 and the light receiver 32 (i.e. light source device capable of sending and receiving optical information).

On the other hand, when the communication mode intended to be introduced is one-way communication and thus it is determined to be “NO” in step ST5, the procedure advances to step ST7. Since the existing LED can be used as is in this case, it is not necessary to replace the light source device (no replacement required).

As described above, when the existing light source is an LED and the communication mode intended to be introduced is two-way communication (sending and receiving information), this case corresponds to pattern C in FIG. 4. Thus, it is necessary to remove the LED to replace it with the light source device 3 including the light emitter (LED) 31 and the light receiver (PD) 32. When the existing light source is an LED and the communication mode intended to be introduced is one-way communication (only sending information), this case corresponds to pattern D in FIG. 4. Thus, it is not necessary to replace the light source device.

In this way, it is determined whether the light source device 3 should be replaced or not, and in the case where it is determined that the replacement is necessary, then it is determined for what kind of light source device 3 the existing light source device should be replaced. After that, in step ST8, it is determined whether the body ECU currently mounted on the vehicle corresponds to the power line communication. It is a user who carries out this determination, for example, by confirming a specification of the vehicle or by visually confirming the actual body ECU.

When the body ECU currently mounted on the vehicle does not correspond to the power line communication, and thus it is determined to be “NO” in step ST8, the procedure advances to step ST9 where it is determined whether the body ECU currently mounted on the vehicle can be replaced with a new body ECU 4 corresponding to the power line communication. For example, when the power distribution line L1 corresponds to the power line communication and furthermore an installation space for the new body ECU 4 corresponding to the power line communication can be ensured (i.e. the installation space for the new body ECU 4 corresponding to the power line communication can be ensured as a space after removing the existing body ECU), then it is determined that the body ECU 4 can be replaced with the new body ECU 4 corresponding to the power line communication.

When the existing body ECU cannot be replaced with the new body ECU 4 corresponding to the power line communication and thus it is determined to be “NO” in step ST9, the procedure advances to step ST10 where it is determined that an ECU corresponding to the power line communication should be inserted in the power distribution line L1 between the light source device 3 and the body ECU (body ECU currently mounted on the vehicle).

When the existing body ECU can be replaced with the new body ECU 4 corresponding to the power line communication and thus it is determined to be “YES” in step ST9, the procedure advances to step ST11 where it is determined that the body ECU currently mounted on the vehicle should be replaced with the new body ECU 4 corresponding to the power line communication.

On the other hand, when the body ECU currently mounted on the vehicle corresponds to the power line communication and thus it is determined to be “YES” in step ST8, the procedure advances to step ST12 where it is determined that although the body ECU 4 is not needed to be replaced, it is necessary to update software stored in the body ECU 4 so that the body ECU 4 has a function to perform power line communication.

In accordance with the respective determination operations, an operator (user) carries out, depending on the situation, parts replacement (replacement of the light source device 3 and/or the body ECU 4) and software updates of the body ECU 4. In this way, the vehicle communication system 1 as described above is built.

Thus, the preparation procedure for building the vehicle communication system 1 was described.

### —Operations to Evaluate Communication Quality—

Now, operations to evaluate communication quality in the above-configured vehicle communication system 1 are described. The communication system (vehicle communication system 1) mounted on the vehicle has complicated communication paths. Thus, in order to put the present invention into practical use, it is important to perform operations to evaluate the communication quality (i.e. whether the stable communication state is ensured) so that the evaluation result of the communication quality serves to adjust various parameters for communication. Thus, the operations to evaluate the communication quality are hereinafter described.

As to the operations to evaluate the communication quality in this embodiment, the following two kinds of operations are performed in this order: first operations to evaluate the communication quality by sending communication quality evaluation signals from the body ECU 4 to the light source device 3; and second operations to evaluate the communication quality by sending communication quality evaluation signals from the light source device 3 to the body ECU 4. Hereinafter, the respective kinds of operations to evaluate the communication quality are described.

### (First Operations to Evaluate Communication Quality)

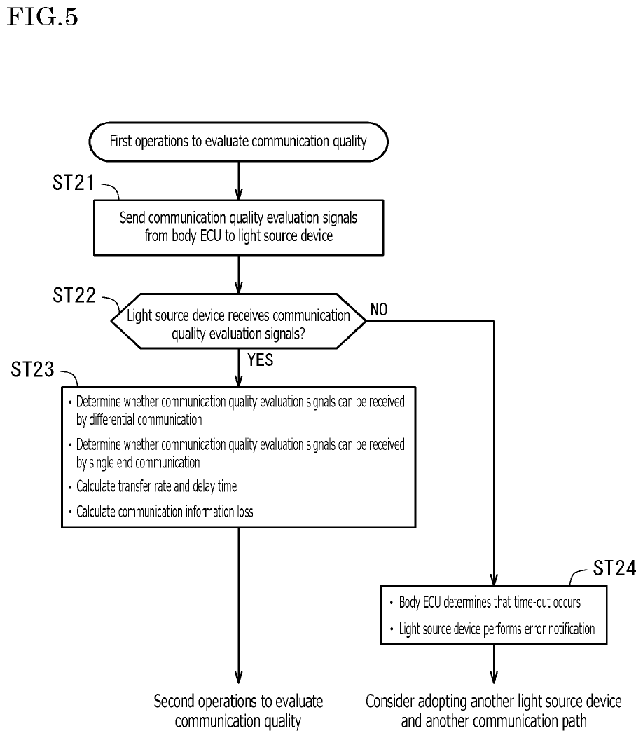

The first operations to evaluate the communication quality are described here. FIG. 5 is a flowchart indicating a procedure of the first operations to evaluate the communication quality. After the preparation for building the vehicle communication system 1 is completed, the first operations to evaluate the communication quality is started by, for example, sending to the body ECU 4 instruction signals to execute the operations to evaluate the communication quality from an outside electronic device such as a personal computer connected to the body ECU 4, or by sending to the body ECU 4 instruction signals to execute the operations to evaluate the communication quality by the wireless communication using the DCM 7.

In the first operations to evaluate the communication quality, in step ST21, the communication quality evaluation signals are sent from the body ECU 4 to the light source device 3 using the power distribution line L1. Specifically, the communication quality evaluation signals are output from the modulation/demodulation circuit 41 of the body ECU 4 to the power distribution line L1, and the communication quality evaluation signals are further transmitted to the modulation/demodulation circuit 33 of the light source device 3.

More specifically, in this operations to evaluate the communication quality, the communication quality evaluation signals at a plurality of superimposed frequencies are transmitted from the body ECU 4 to the light source device 3 by differential communication. Also, the communication quality evaluation signals at a plurality of superimposed frequencies are transmitted from the body ECU 4 to the light source device 3 by single end communication. For example, after the transmission of the communication quality evaluation signals by the differential communication, the communication quality evaluation signals are further transmitted by the single end communication, if necessary.

As publicly known, the differential communication is a communication mode in which two kinds of currents respectively having phases reverse to each other are applied to two signal lines so as to send/receive information using potential difference between the signal lines. With the differential communication, noise resistance can be generally improved. Also as publicly known, the single end communication is a communication mode in which one signal line is used to generate signals as potential difference with respect to the ground level.

The communication quality evaluation signals include information on the signal transmission time and information on data values for evaluating the error rate. The information on the signal transmission time is used to calculate the speed (transfer rate) and the delay time of the signals transmitted from the body ECU 4 to the light source device 3. The information on the data values for evaluating the error rate is used to calculate communication information loss. Lowering of the transfer rate, generation of the communication delay and communication information loss are caused by impedance discontinuity by wiring connectors.

After sending the communication quality evaluation signals from the body ECU 4 to the light source device 3, in step ST22, it is determined whether the light source device 3 (in particular, the modulation/demodulation circuit 33 of the light source device 3) receives the communication quality evaluation signals or not.

When the modulation/demodulation circuit 33 of the light source device 3 receives the communication quality evaluation signals and thus it is determined to be “YES” in step ST22, the procedure advances to step ST23 where the following processing is performed: determining whether the communication quality evaluation signals can be received by the differential communication; determining whether the communication quality evaluation signals can be received by the single end communication; calculating the transfer rate and the delay time based on the information on the signal transmission time; and calculating the communication information loss based on the information on the data values for evaluating the error rate. After that, the procedure advances to the second operations to evaluate the communication quality described later.

On the other hand, when the modulation/demodulation circuit 33 of the light source device 3 does not receive the communication quality evaluation signals and thus it is determined to be “NO” in step ST22, the procedure advances to step ST24. In this case, the body ECU 4 determines that time-out occurs because no response is received within a predetermined time period. Thus, it is determined that the communication cannot be adopted. Also, the light source device 3 determines that the communication is not established because the communication quality evaluation signals are not received. Thus, the light source device 3 performs error notification to the interior of the vehicle. As to the error notification, light is flashed, or a light having a color different from the normal light (i.e. the color light different from that in the wireless communication) is emitted by the light emitter 31. And in this case, it is considered which light is adopted as the light source device 3 and which communication path is used in order to build the vehicle communication system 1 using another light source device (another lamp). Specifically, when the communication is not established in the case of adopting the room lamp as the light source device 3, it is considered, for example, whether a map lamp should be adopted as the light source device 3 (and the replacement of the light source device 3 should be carried out in accordance with the pattern in FIG. 4).

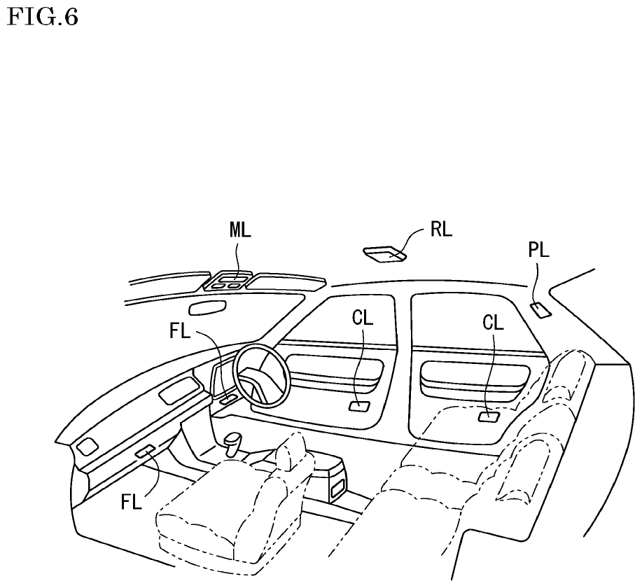

FIG. 6 is a diagram illustrating an example of installation locations of the in-vehicle light source devices (in this diagram, the seats in the vehicle are indicated by the virtual lines). As shown in FIG. 6, the vehicle includes, in the inside thereof, the light source devices (lamps) such as a personal lamp PL, a foot lamp FL, and a courtesy lamp CL apart from the room lamp RL and the map lamp ML as described above. Thus, when the room lamp RL is adopted as the light source device 3 and the communication is not established, the light to be adopted as the light source device 3 is changed to the map lamp ML. If the communication is not established in this case also, then the light to be adopted as the light source device 3 is changed to the personal lamp PL. In this way, the lamp to be adopted as the light source device 3 is sequentially changed. Examples of other lamps that can be adopted as the light source device 3 in the vehicle communication system 1 include: lamps on a meter panel; and lamps on a center console.

After the change of the lamp to be adopted as the light source device 3, when the thus changed light source device 3 receives the communication quality evaluation signals and it is determined to be “YES” in step ST22, the procedure advances to step ST23 where the following processing is performed: determining whether the signals can be received or not; and calculating the transfer rate, the delay time, and the communication information loss. After that, the procedure advances to the second operations to evaluate the communication quality described later.

In the first operations to evaluate the communication quality, the communication quality evaluation signals transmitted from the body ECU 4 to the light source device 3 are also transmitted from the light source device 3 to the terminal device 2 by optical wireless communication (when the communication is normally performed). Thus, it is also possible to evaluate the communication quality between the terminal device 2 and the light source device 3 based on the signal reception status of the terminal device 2. However, the operations to evaluate the communication quality between the terminal device 2 and the light source device 3 may be performed separately from the first operations to evaluate the communication quality.

### (Second Operations to Evaluate Communication Quality)

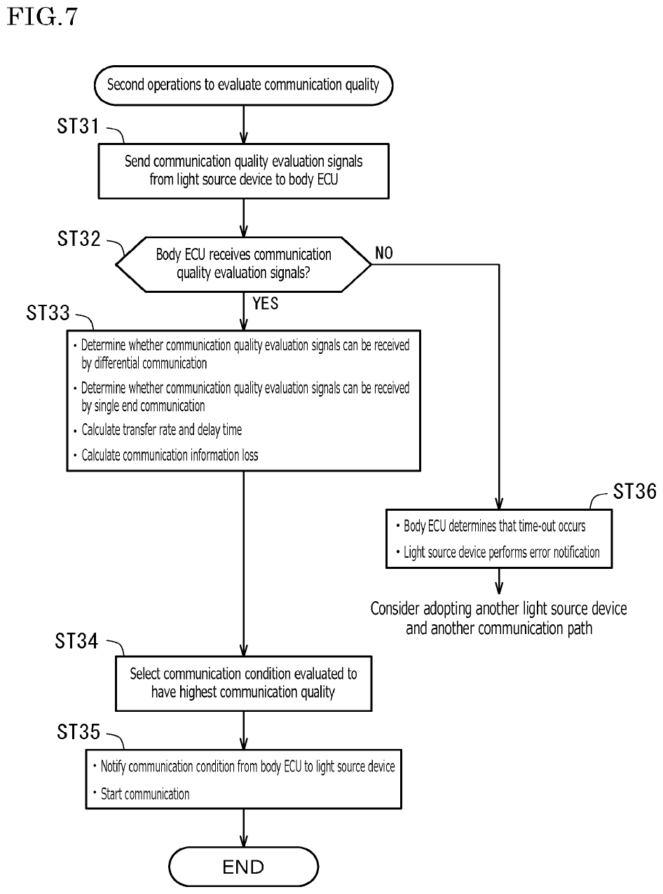

Next, the second operations to evaluate the communication quality are described here. FIG. 7 is a flowchart indicating a procedure of the second operations to evaluate the communication quality. The second operations to evaluate the communication quality is started after the light source device 3 receives the communication quality evaluation signals in the first operations to evaluate the communication quality as described above.

In the second operations to evaluate the communication quality, in step ST31, the communication quality evaluation signals are sent from the light source device 3 to the body ECU 4 using the power distribution line L1. Specifically, the communication quality evaluation signals are output from the modulation/demodulation circuit 33 of the light source device 3 to the power distribution line L1, and the communication quality evaluation signals are further transmitted to the modulation/demodulation circuit 41 of the body ECU 4.

More specifically, in this operations to evaluate the communication quality, the communication quality evaluation signals at a plurality of superimposed frequencies are transmitted from the light source device 3 to the body ECU 4 by the differential communication. Also, the communication quality evaluation signals at a plurality of superimposed frequencies are transmitted from the light source device 3 to the body ECU 4 by the single end communication. For example, after the transmission of the communication quality evaluation signals by the differential communication, the communication quality evaluation signals are further transmitted by the single end communication, if necessary.

Also, the communication quality evaluation signals include information on the signal transmission time and information on data values for evaluating the error rate, similarly to the first operations to evaluate the communication quality. In addition to the above, in the second operations to evaluate the communication quality, the information obtained in step ST23 in the first operations to evaluate the communication quality is also transmitted (i.e. the information on whether the communication quality evaluation signals can be received by the differential communication; the information on whether the communication quality evaluation signals can be received by the single end communication; the information on the transfer rate and the delay time calculated based on the information on the signal transmission time; and the information on the communication information loss calculated based on the information on the data values for evaluating the error rate).

After sending the communication quality evaluation signals from the light source device 3 to the body ECU 4, in step ST32, it is determined whether the body ECU 4 (in particular, the modulation/demodulation circuit 41 of the body ECU 4) receives the communication quality evaluation signals or not.

When the modulation/demodulation circuit 41 of the body ECU 4 receives the communication quality evaluation signals and thus it is determined to be “YES” in step ST32, the procedure advances to step ST33 where the following processing is performed: determining whether the communication quality evaluation signals can be received by the differential communication; determining whether the communication quality evaluation signals can be received by the single end communication; calculating the transfer rate and the delay time based on the information on the signal transmission time; and calculating the communication information loss based on the information of the data values for evaluating the error rate. In the step ST33, the determination whether the communication quality evaluation signals can be received or not and the calculation of the transfer rate, the delay time and the communication information loss are executed also using the information obtained in step ST23 in the first operations to evaluate the communication quality as described above.

After that, the procedure advances to step ST34 where the communication condition that is evaluated to have the highest communication quality is selected. Specifically, the communication quality of the differential communication and the communication quality of the single end communication are evaluated (i.e. the transfer rate, the delay time and the communication information loss are respectively evaluated), and the communication evaluated to have a higher communication quality is selected. In this case, when the evaluation results of the communication quality of the respective communications are substantially equal, the differential communication, with which high-speed communication can be expected, is selected. Also, the conditions to select the single end communication meet the following states: the evaluation result of the communication quality of the single end communication is higher than the evaluation result of the communication quality of the differential communication; and the transfer rate in the single end communication is not less than 10 Mbps. When the single end communication is selected, the communication signals are generated as potential difference with respect to the ground level.

Also in step ST34, the communication quality evaluation signals at the plurality of superimposed frequencies are evaluated, and the communication condition of the superimposed frequency that is evaluated to have the highest communication quality is selected.

In this way, after the communication condition (i.e. the differential communication or the single end communication, the suitable superimposed frequency, etc.) is selected, the procedure advances to step ST35 where the information on the selected (determined) communication condition is transmitted (notified) from the body ECU 4 to the light source device 3 using the power distribution line L1. Thus, the body ECU 4 and the light source device 3 acquire the communication condition for the power line communication (PLC) using the power distribution line L1, and start the power line communication under the acquired communication condition.

On the other hand, when the modulation/demodulation circuit 41 of the body ECU 4 does not receive the communication quality evaluation signals and thus it is determined to be “NO” in step ST32, the procedure advances to step ST36. In this case, the body ECU 4 determines that time-out occurs because no signal is received within a predetermined time period. Thus, it is determined that the communication cannot be adopted. Also, the light source device 3 determines that the communication is not established, and performs error notification to the interior of the vehicle. As to this error notification also, light is flashed, or a light having a color different from the normal light is emitted by the light emitter 31. And in this case, it is considered which light is adopted as the light source device 3 and which communication path is used in order to build the vehicle communication system 1 using another light source device (another lamp). Specifically, when the communication is not established in the case of adopting the room lamp RL as the light source device 3 as described above, it is considered, for example, whether the map lamp ML should be adopted as the light source device 3.

Thus, the operations to evaluate the communication quality were described.

It is preferable that the above operations to evaluate the communication quality are performed not only at a time when the vehicle communication system 1 is built, but also every predetermined time period (periodically) after the start of the communication, taking into account possible disturbance due to the surrounding environment. In this way, it is possible to continue the communication under the optimal communication condition even when disturbance occurs due to the surrounding environment.

### —Processing According to Result of Operations to Evaluate Communication Quality—

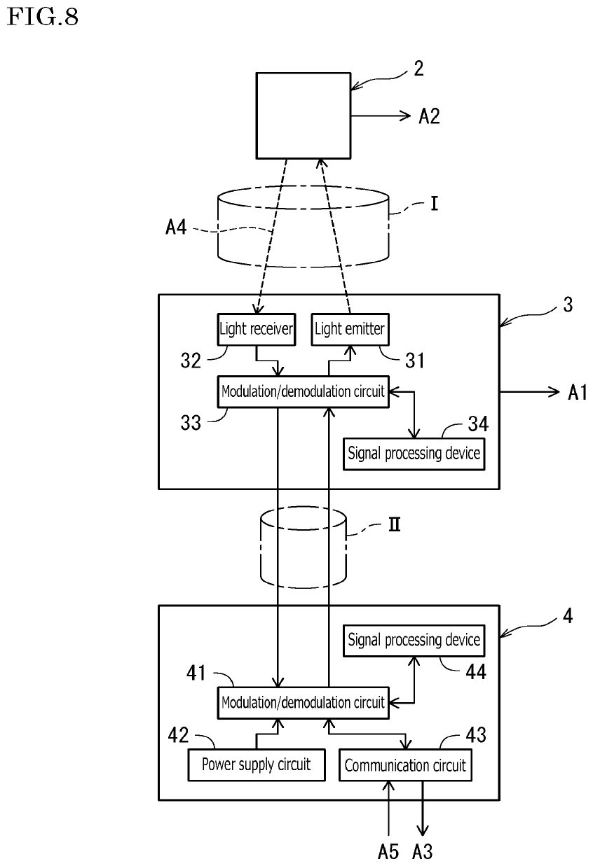

Here, the processing according to the result of the operations to evaluate the communication quality is described. FIG. 8 is a block diagram corresponding to FIG. 2, which explains processing according to the result of operations to evaluate the communication quality. This processing includes: an operation to output the result of the operations to evaluate the communication quality; and an operation to adjust the communication condition according to the result of the operations to evaluate the communication quality.

When it is determined, by the operations to evaluate the communication quality, that the communication is not established, it is considered which light is adopted as the light source device 3 and which communication path is used in order to build the vehicle communication system 1 using another light source device (another lamp). In addition to the above, the light is flashed, or the light having a color different from the normal light is emitted by the light emitter 31. Also, as indicated by the arrow A3 in FIG. 8, the body ECU 4 notifies the other ECUs installed in the vehicle of information on the result of the operations to evaluate the communication quality. That is, the information that the communication is not established is shared by the respective ECUs.

On the other hand, when it is determined, by the operations to evaluate the communication quality, that the communication is established, the following outputs are performed: output of the result of the operations to evaluate the communication quality from the light source device 3 as indicated by the arrow A1 in FIG. 8 (for example, emitting light from the light emitter 31 to indicate the establishment of the communication); output of the result of the operations to evaluate the communication quality from the terminal device 2 as indicated by the arrow A2 in FIG. 8; and output of the result of the operations to evaluate the communication quality from the body ECU 4 as indicated by the arrow A3 in FIG. 8.

Thus, based on the above pieces of information, the information to adjust the communication condition is fed back to the light source device 3 and the body ECU 4. Specifically, information that is fed back from the terminal device 2 to the light source device 3 as indicated by the arrow A4 in FIG. 8 is information to adjust the communication condition such as a frequency under which the communication quality is optimized between the terminal device 2 and the light source device 3, which is obtained based on the result of the operations to evaluate the communication quality between the terminal device 2 and the light source device 3 (i.e. the result of the operations to evaluate the communication quality performed on the target section indicated by the dashed-dotted line I in FIG. 8). The information to adjust the communication condition may be automatically generated by the terminal device 2 and to be output to the light source device 3, or may be manually operated by an occupant using application software installed in the terminal device 2 to be output to the light source device 3. Also, the information that is fed back to the body ECU 4 as indicated by the arrow A5 in FIG. 8 is information to adjust the communication condition such as a frequency under which the communication quality is optimized between the body ECU 4 and the light source device 3, which is obtained based on the result of the operations to evaluate the communication quality between the body ECU 4 and the light source device 3 (i.e. the result of the operations to evaluate the communication quality performed on the target section indicated by the dashed-dotted line II in FIG. 8). Any ECU other than the body ECU 4 may generate the information that is fed back to the body ECU 4.

In accordance with the information that is fed back as described above, the communication condition in the light source device 3 and the body ECU 4 is adjusted. Thus, it is possible to realize the communication with excellent communication quality and to ensure the stable communication state.

### —Usage of Vehicle Communication System—

Here, the usage of the above-configured vehicle communication system 1 is described. In the vehicle communication system 1 of this embodiment, only the terminal device 2 that is on a service contract with the vehicle communication system 1 (i.e. the terminal device 2 operated by a user who enters into the service contract and logs in the vehicle communication system 1) can enjoy communications service with the light source device 3 by optical wireless communication.

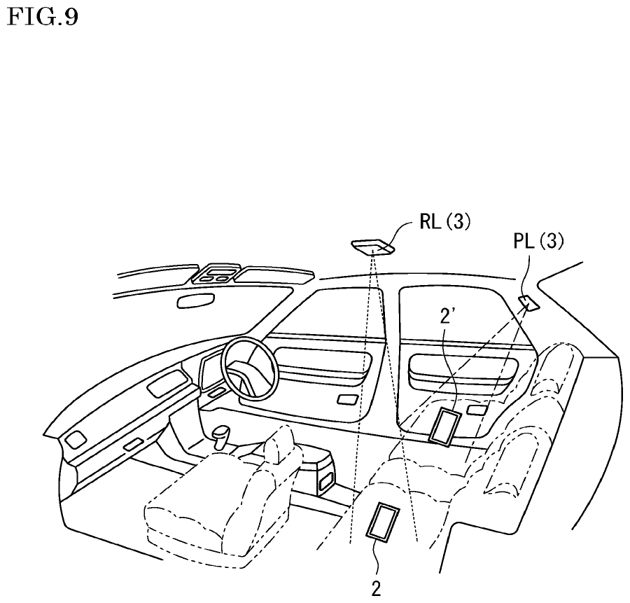

Thus, as shown in FIG. 9, when two terminal devices (terminal devices carried by the occupants) 2 and 2′ are in the vehicle, and furthermore when the terminal device 2 is on the service contract while the terminal device 2′ is not on the service contract, only the terminal device 2 can receive the service provided by the vehicle communication system 1. Therefore, the terminal device 2 receives the light from the light source device 3 (for example, the room lamp RL) so as to perform optical wireless communication with the light source device 3. In this case, the light from the light source device 3 can be the visible light, the infrared light and the ultraviolet light, as described above. When the visible light is used, the occupant can recognize the range in which the optical wireless communication can be performed as the emission range of the visible light. Also, when it is not preferable to irradiate the inside of the vehicle with the visible light, for example, in the daytime, the light emitted from the light source device 3 may be changed to the infrared light or the ultraviolet light. In this way, it is possible to perform the optical wireless communication while meeting the requirement of the occupant (i.e. the requirement not to irradiate the inside of the vehicle with the visible light).

On the other hand, the terminal device 2′ cannot perform the optical wireless communication with the light source device 3 even when the terminal device 2′ receives the light emitted from the light source device 3 (for example, personal lamp PL).

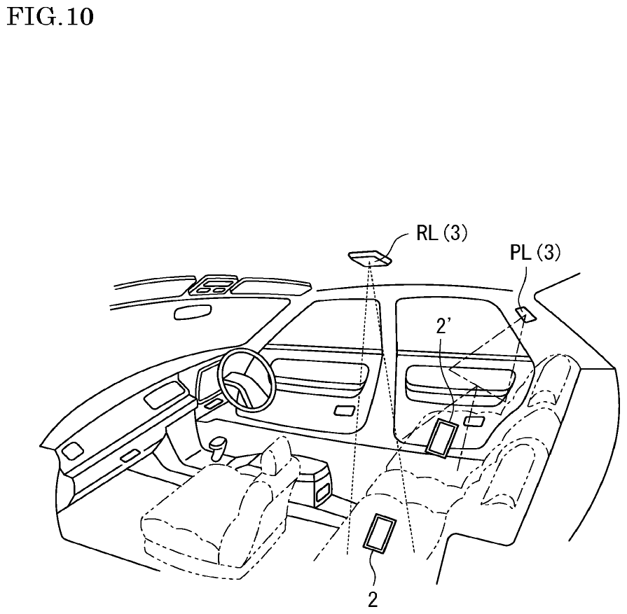

FIG. 10 is a diagram illustrating the interior of the vehicle when it is determined, by the operations to evaluate the communication quality, that the communication is not established. In FIG. 10 also, the terminal device 2 is on the service contract while the terminal device 2′ is not on the service contract.

When it is determined that the communication is not established, the light having a color different from the normal light (i.e. the color different from that in the wireless communication) is emitted by the light emitter 31, as described above. For example, when the light emitter 31 is provided with an LED that emits a white light and an LED that emits a red light, and when the communication is being established, the light emitter 31 emits the white light. In contrast, when the communication is not established, the light emitter 31 emits the red light. FIG. 10 shows a state in which the red light is emitted from the light source device 3 (for example, the room lamp RL) to the terminal device 2 (i.e. the terminal device 2 that is on the service contract). Thus, the occupant can easily recognize the communication state by seeing the light emitted from the light emitter 31 of the light source device 3. In this case, the communication is continuously attempted using the red light as the light for the optical wireless communication.

Also in the state illustrated in FIG. 10, the light emitted from the light emitter 31 to the terminal device 2′ (i.e. the terminal device 2′ that is not on the service contract) is flashing, which encourages the occupant carrying the terminal device 2′ to enter into the service contract.

In this embodiment, when it is determined that the communication is not established, the red light is emitted to the terminal device 2 that is on the service contract while the flash light is emitted to the terminal device 2′ that is not on the service contract. However, the present invention is not limited thereto. The flash light may be emitted to the terminal device 2 that is on the service contract while no light is emitted to the terminal device 2′ that is not on the service contract.

### —Effects of Embodiment—

As described above, the system in this embodiment has a configuration in which: the terminal device 2 can communicate with the light source device 3 by the wireless communication; the body ECU 4 connected to the light source device 3 by the power distribution line L1 is connected, by the wired connection, to the DCM 7 capable of performing the wireless communication with the outside of the vehicle; and the light source device 3 and the body ECU 4 can communicate with each other by the power line communication using the power distribution line L1. With this configuration, the light source device 3 can send information to and receive information from the outside of the vehicle via the body ECU 4 and the DCM 7. Thus, it is possible to build the vehicle communication system 1 that realizes wireless communication between the outside of the vehicle and the in-vehicle wireless communication environment (i.e. in-vehicle wireless communication environment configured including the terminal device 2 and the light source device 3). Especially, since the vehicle is mostly made of metal, it is difficult for radio wave to reach the inside of the vehicle when the communication mode using radio wave is intended to be adopted. However, in this embodiment, since the communication with the outside of the vehicle is possible by the vehicle external antenna 71 and furthermore the terminal device 2 communicates with the light source device 3 by the optical wireless communication, it is possible to obtain a good communication state even in the vehicle.

Also in this embodiment, the operations to evaluate the communication quality between the light source device 3 and the body ECU 4 are performed, and the communication condition evaluated to have the highest communication quality (i.e. the differential communication or the single end communication, the suitable superimposed frequency, etc.) is selected so as to perform the communication between the light source device 3 and the body ECU 4. In this way, it is possible to ensure the stable communication state between the light source device 3 and the body ECU 4, which improves practicability of the vehicle communication system 1 having complicated communication paths.

Also in this embodiment, the result of the operations to evaluate the communication quality that is output from the light source device 3 to the inside of the vehicle is indicated by the color of light emitted from the light emitter 31, which is predetermined according to the determination result. That is, when the communication is established, the white light is emitted from the light emitter 31 while the red light is emitted from the light emitter 31 when the communication is not established. Thus, the occupant can easily recognize the communication state between the light source device 3 and the body ECU 4 by seeing the light emitted from the light emitter 31 of the light source device 3.

Also in this embodiment, the result of the operations to evaluate the communication quality is fed back to the light source device 3 and the body ECU 4 so as to adjust the communication condition. Thus, it is possible to ensure the stable communication state and to improve practicability of the vehicle communication system 1.

### Example of Application to One-Way Communication

In the vehicle communication system 1 of the above-described embodiment, the two-way communication is performed between the light source device 3 and the terminal device 2. However, the present invention also includes, as described above, the system that is built as the vehicle communication system 1 in which the only one-way communication is performed from the body ECU 4 to the light source device 3, and from the light source device 3 to the terminal device 2. In this vehicle communication system 1 for only one-way communication, the light source device 3 is provided with only the light emitter 31 while the terminal device 2 is provided with only the light receiver 22, although this configuration is not shown in the drawings. That is, the optical wireless communication is performed by receiving the light emitted from the light emitter 31 of the light source device 3 by the light receiver 22 of the terminal device 2.

Now, in the above-described vehicle communication system 1 for only one-way communication, description will be given on the operations to evaluate the communication quality and the processing according to the result of the operations to evaluate the communication quality.

In the vehicle communication system 1 for one-way communication, only the one-way communication is performed from the body ECU 4 to the light source device 3. Thus, as to the operations to evaluate the communication quality, only the first operations to evaluate the communication quality are performed.

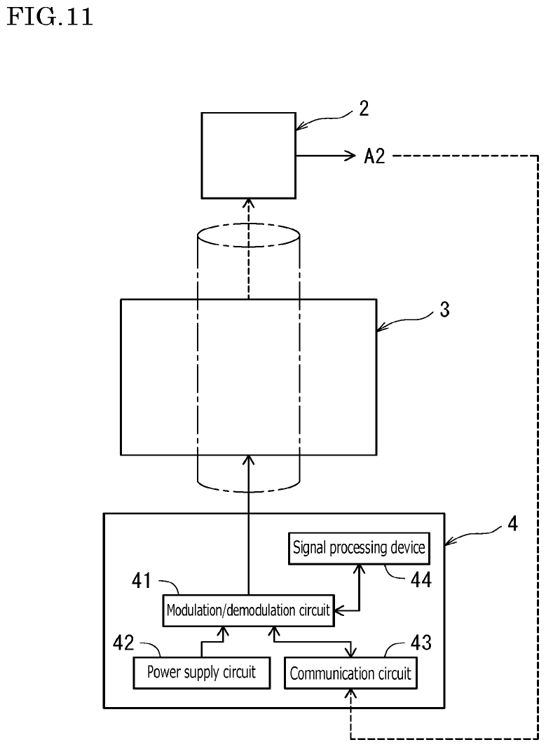

FIG. 11 is a block diagram corresponding to FIG. 2, which explains the processing according to the result of the operations to evaluate the communication quality.

When it is determined, by the operations to evaluate the communication quality, that the communication is not established, it is considered which light is adopted as the light source device 3 and which communication path is used in order to build the vehicle communication system 1 using another light source device (another lamp), in the same way as that in the above-described embodiment.

On the other hand, when it is determined, by the operations to evaluate the communication quality, that the communication is established, the terminal device 2 receives the communication quality evaluation signals so that the terminal device 2 recognizes the evaluation result (score) of the communication condition, the communication mode and the like. Then, information to adjust the communication condition such as a frequency under which the communication quality is optimized is fed back from the terminal device 2 to the body ECU 4, as indicated by the arrow A2 in FIG. 11. In this case, it is necessary to have communication means for transmitting the feedback information from the terminal device 2 to the body ECU 4. For example, it is required to have a configuration in which the communication via Wi-Fi can be performed, or in which the terminal device 2 and the body ECU 4 are temporarily connected by the wired connection so as to transmit the feedback information. The information to adjust the communication condition may be automatically generated by the terminal device 2 and to be output to the body ECU 4, or may be manually operated by the occupant using application software installed in the terminal device 2 to be output to the body ECU 4. By adjusting the communication condition in the communication path from the body ECU 4 to the terminal device 2 by the feedback information, it is possible to realize the communication with excellent communication quality and to ensure the stable communication state.

### —Variation—

Here, a variation is described. In the above-described embodiment, the vehicle communication system 1 is applied to a passenger car. In this variation, the vehicle communication system 1 is applied to a transit bus.

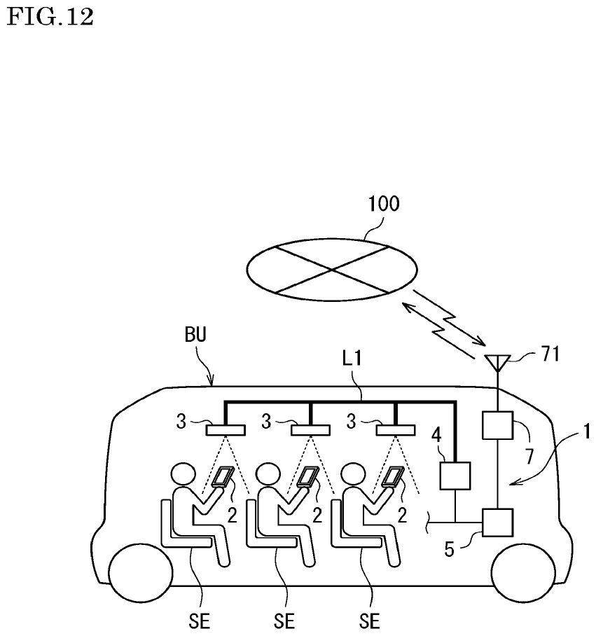

FIG. 12 is a schematic diagram illustrating an example in which the vehicle communication system 1 is applied to a transit bus BU. As shown in FIG. 12, the vehicle communication system 1 according to this variation is built as a system in which the communication to send information to and receive information from the terminal devices 2 respectively carried by a plurality of occupants sitting in seats SE of the transit bus BU.

Specifically, the vehicle communication system 1 includes: the light source device 3; the body ECU 4; the gateway ECU 5; the various ECUs (not shown); and the DCM 7, similarly to the system 1 in the above-described embodiment. The vehicle communication system 1 according to this variation has a feature that a plurality of light source devices 3 is provided on the ceiling surface so as to correspond to the respective seats SE of the transit bus BU, and the light source devices 3 are respectively connected to the body ECU 4 by the power distribution line L1. Thus, the terminal devices 2 carried by the occupants can communicate with the respective light source devices 3 disposed right above by the optical wireless communication.

Also in the vehicle communication system 1 of this variation, only the terminal device 2 that is on a service contract with the vehicle communication system 1 (i.e. the terminal device 2 operated by a user who enters into the service contract and logs in the vehicle communication system 1) can enjoy communications service with the light source device 3 by the optical wireless communication. The other configurations and operations (i.e. the operations to evaluate the communication quality, the processing according to the result of the operations to evaluate the communication quality and the like) are the same as those in the above-described embodiment.

Also in this variation, it is possible to build the vehicle communication system 1 that realizes wireless communication between the outside of the vehicle and the in-vehicle wireless communication environment (i.e. in-vehicle wireless communication environment configured including the terminal devices 2 and the light source devices 3), in the same manner as the above-described embodiment.

### Other Embodiments

The present invention is not limited to the above-described embodiment and the variation. All modifications and changes that come within the meaning and range of equivalency of the claims are intended to be embraced therein.

For example, in the embodiment and the variation as described above, the communication system for transport means (i.e. the vehicle communication system 1) is applied to a passenger car or a transit bus. However, the present invention is not limited thereto. The system 1 can be applied to various transport means such as a railroad vehicle, an airplane, and a vessel.

Also, in the embodiment and the variation as described above, the operations to evaluate the communication quality are performed to evaluate the communication quality between the respective components on the communication path from the terminal device 2 to the body ECU 4. However, the present invention is not limited thereto. For example, the operations may be performed to evaluate the communication quality between the body ECU 4 and the DCM 7 so as to adjust the communication condition to reflect the result of the operations to evaluate the communication quality and thus to ensure the stable communication state between the body ECU 4 and the DCM 7. Also, the operations may be performed to evaluate the communication quality on the communication path from the terminal device 2 to the DCM 7 so as to adjust the communication condition to reflect the result of the operations to evaluate the communication quality and thus to ensure the stable communication state on the communication path from the terminal device 2 to the DCM 7.

Also in the embodiment and the variation as described above, a smartphone is exemplarily explained as the terminal device 2 carried by the occupant. However, the present invention is not limited thereto. The vehicle communication system 1 may be built as a system to perform wireless communication (such as optical wireless communication) between various components installed in the interior of the vehicle (for example, a car navigation device, an audio device, and an air conditioning device) and the light source device 3.

Also in the embodiment and the variation as described above, the result of the operations to evaluate the communication quality is notified by emission of light from the light source device 3 to the interior of the vehicle. However, the present invention is not limited thereto. The result of the operations to evaluate the communication quality may be notified to the interior of the vehicle by sound. For example, the light source device 3 may have a built-in speaker, or alternatively, the result information of the communication quality evaluation may be transmitted to the existing speaker (such as an in-vehicle speaker and a speaker of the terminal device 2). Thus, the evaluation result is notified to the interior of the vehicle by sound from the speaker.

Also in the embodiment and the variation as described above, the case is exemplarily described, in which only the terminal device 2 that is on the service contract with the vehicle communication system 1 can enjoy communications service with the light source device 3 by optical the wireless communication. However, the present invention is not limited thereto. All the terminal devices 2 in the vehicle may enjoy communications service with the light source device 3 by the optical wireless communication, regardless of whether the terminal devices 2 are on the contract or not.

### INDUSTRIAL APPLICABILITY

The present invention is applicable to a vehicle communication system by which wireless communication can be performed between the outside of the vehicle and the wireless communication environment in the vehicle.

### REFERENCE SIGNS LIST

1 Vehicle communication system (communication system for transport means)
2 Terminal device
3 Light source device (communication device)
31 Light emitter
32 Light receiver
4 Body ECU (control device)
7 DCM (wireless communication device)
100 Network
L1 Power distribution line

What is claimed is:

1. A communication system for transport means, comprising:
a communication device performing wireless communication with a terminal device in an interior of transport means;
a control device connected to the communication device by a power distribution line; and
a wireless communication device connected to the control device by wired connection, the wireless communication device performing wireless communication with an outside, wherein
the communication device and the control device communicate with each other by power line communication using the power distribution line.

2. The communication system for transport means according to claim 1, wherein
operations to evaluate communication quality are performed by sending and receiving communication quality evaluation signals between the communication device and the control device under a plurality of communication conditions using the power distribution line so as to select and determine a communication condition between the communication device and the control device using the power distribution line among the plurality of communication conditions.

3. The communication system for transport means according to claim 2, wherein
in the operations to evaluate the communication quality, first operations to evaluate the communication quality are performed by sending the communication quality evaluation signals from the control device to the communication device using the power distribution line, and furthermore second operations to evaluate the communication quality are performed by sending communication quality evaluation signals from the communication device to the control device using the power distribution line.

4. The communication system for transport means according to claim 2, wherein
a result of the operations to evaluate the communication quality between the communication device and the control device is output from the communication device to the interior of the transport means.

5. The communication system for transport means according to claim 4, wherein
the communication device includes a light emitter, and
the result of the operations to evaluate the communication quality, which is output from the communication device to the interior of the transport means, is indicated by the light emitter as a color of emitted light or a flash of emitted light that is predetermined corresponding to the result.

6. The communication system for transport means according to claim 2, wherein
a result of the operations to evaluate the communication quality is fed back to the control device so as to adjust the communication condition between the control device and the communication device.

7. The communication system for transport means according to claim 1, wherein
operations to evaluate communication quality between the terminal device and the communication device are performed by the wireless communication, and
a result of the operations to evaluate the communication quality is fed back to the communication device so as to adjust a communication condition between the communication device and the terminal device.

8. The communication system for transport means according to claim 1, wherein
the wireless communication performed between the terminal device and the communication device is optical wireless communication.

9. The communication system for transport means according to claim 8, wherein
the communication device includes a light emitter and a light receiver to perform the optical wireless communication with the terminal device, or includes only the light emitter to send information to the terminal device by the optical wireless communication.

10. The communication system for transport means according to claim 9, wherein
the communication device includes only the light emitter,
operations to evaluate communication quality at least between the control device and the communication device on a communication path from the control device to the terminal device are performed, and
a result of the operations to evaluate the communication quality is fed back from the terminal device to the control device so as to adjust a communication condition on the communication path from the control device to the terminal device.
